(19) United States
(12) Patent Application Publication
(10) Pub. No.: US 2004/0141060 A1
(43) Pub. Date: Jul. 22, 2004

(54) Surveillance camera system

(76) Inventor: Masatoshi Tsuji, Ohtsu-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/740,811

(22) Filed: Dec. 22, 2003

(30) Foreign Application Priority Data
Jan. 20, 2003 (JP) 2003-010870

(51) Int. Cl. H04N 7/18

(52) U.S. Cl. 348/152; 348/143

(57) ABSTRACT

A surveillance camera system is provided with sensors that detect an intruder in a detection area of respectively removed locations connected to a single camera that performs image-taking of the intruder. The detection area is constituted by a wide detection area in which wide-angle image-taking is performed, and sectional detection areas into which the wide detection area is divided and in which enlarged image-taking is performed. The sensor is provided with a control portion that simultaneously performs transmission of an image-taking signal commanding the camera to perform image-taking upon detection of an intruder in the wide detection area, and transmission of an image-taking signal commanding the camera to perform image-taking upon the detection of an intruder in the sectional detection areas, upon detection of the intruder.

### BACKGROUND OF THE INVENTION

The present invention relates to surveillance camera systems that use a sensor to detect an intruder in a detection area, and then perform image-taking of the intruder with a camera which is connected to the sensor.

Conventionally, surveillance camera systems are provided with a sensor that detects intruders in a detection area and a camera that performs image-taking of intruders, wherein image-taking of the intruder is performed with the camera after an intruder is detected in the detection area by the sensor.

The sensors referred to here are sensors that can perform detection for a wide-area detection area (hereafter “wide detection area”) and a narrow-area detection area (hereafter “narrow detection area”) (see Japanese Laid-Open Patent Publication No. Hei 9-5610 for example).

As shown in FIG. 6, with the sensors disclosed in Japanese Laid-Open Patent Publication No. Hei 9-5610, area sensors 91 and 92 are constituted by central portions 93 and 94 and peripheral portions 95 and 96 that have different pixel pitches, and the pixels are electronically switched by a readout means so that the area sensors obtain two kinds of detection area information (wide detection area information and narrow detection area information). In other words, photoelectric conversion is performed for a large surface area (for the wide detection area) in the large block sensors 95 and 96, and photoelectric conversion is performed for the central portions (for the narrow detection area) in the small block sensors 93 and 94, so that combined use is made of examination of wide detection area information and examination of narrow detection area information.

In conventional surveillance camera systems, after the position of an intruder in the detection area is detected, only enlarged image-taking of the position of the intruder is performed, or only wide-angle image-taking of the detection area in which detection has occurred is performed. This is also true for surveillance camera systems that use a sensor according to the above-mentioned Japanese Laid-Open Patent Publication No. Hei 9-5610.

For this reason, when performing enlarged image-taking of an intruder in a narrow detection area, there are times when image-taking of the intruder will not occur due to a detection discrepancy in which, because the intruder moves, the intruder departs from the narrow detection area (that is, the intruder is not present at the time of image-taking). In particular, when dual-frequency microwaves are transmitted to the detection area and an intruder is present in the detection area, a sensor that uses microwaves and detects a target by receiving reflected waves from the intruder requires time to discover the intruder, since the distance from the sensor to the intruder must be calculated to define the detection area. And in this way, the intruder may have already moved to another location by the time enlarged image-taking is performed once the distance is calculated, and image-taking of the intruder may not be able to be achieved even when enlarged image-taking is preformed.

Also, when a plurality of narrow detection areas are arranged in locations far removed from each other, and image-taking of these remote narrow detection areas is performed by a camera, enlarged image-taking of the intruder is performed once the camera is facing the narrow detection area in which the intruder is present. And thus time is required to move the camera before it faces the narrow detection area in which the intruder is present, so that by the time of image-taking, the intruder may have already moved from that detection area and it may not be possible to achieve image-taking of the intruder even when enlarged image-taking is performed.

In a detection area constituted by only wide detection areas, wide-angle image-taking of the intruder is possible even if the intruder moves, since the detection area is wide. However, with just wide-angle image-taking, the figure of the intruder is small in comparison to the entire size of the image, and the intruder cannot be reliably specified.

In order to solve these issues, an object of the present invention is to provide a surveillance camera system that shortens the time from the detection of an intruder until image-taking of the intruder is performed by a camera, can perform reliable image-taking and specify an intruder.

### SUMMARY OF THE INVENTION

In order to achieve the above object, the surveillance camera system according to the present invention is provided with a sensor that detects an intruder in a detection area and a camera that performs image-taking of the intruder, wherein image-taking of the intruder is performed with the camera after the intruder is detected in the detection area by the sensor, wherein the image-taking of the intruder by the camera is performed with enlarged image-taking and wide-angle image-taking, wherein the detection area is constituted by a wide detection area in which the wide-angle image-taking is performed, and a plurality of sectional detection areas into which the wide detection area is divided and in which enlarged image-taking is performed, and wherein the sensor is provided with a control portion that simultaneously performs transmission of an image-taking signal commanding the camera to perform image-taking upon detection of an intruder in the wide detection area, and transmission of an image-taking signal commanding the camera to perform image-taking upon the detection of an intruder in the sectional detection areas, upon detection of the intruder.

According to this invention, image-taking of the intruder by camera is performed with enlarged image-taking and wide-angle image-taking, and the detection area is constituted by a wide detection area and sectional detection areas, and the sensor is provided with a control portion so that transmission of an image-taking signal commanding the camera to perform image-taking upon detection of an intruder in the wide detection area, and transmission of an image-taking signal commanding the camera to perform image-taking upon the detection of an intruder in the sectional detection areas, are performed simultaneously upon detection of the intruder. The result of this is that it is possible to perform wide-angle image-taking in the wide detection area, and enlarged image-taking in the sectional detection areas, thus enabling the intruder to be reliably specified with wide-angle image-taking and enlarged image-taking. Furthermore, with the control portion, transmission of an image-taking signal commanding the camera to perform image-taking upon detection of an intruder in the wide detection area, and transmission of an image-taking signal commanding the camera to perform image-taking upon the detection of an intruder in the sectional detection areas are performed simultaneously upon detection of the intruder, and therefore the time until wide-angle image-taking and enlarged image-taking are performed of the intruder by the camera upon detection of the intruder can be shortened.

In the above-described configuration, it is also possible that the control portion controls the transmission of the image-taking signals so that the enlarged image-taking is performed after the wide-angle image-taking of the intruder by the camera.

In this case, since the control portion controls the transmission of the image-taking signals so that the enlarged image-taking is performed after the wide-angle image-taking of the intruder by the camera, it is possible, first, to reliably perform image-taking of the intruder with wide-angle image-taking, and then, to perform enlarged image-taking for specifying the intruder, thus preventing a failure to perform image-taking of the intruder and enabling the intruder to be specified with reliable image-taking.

In the above-described configuration, it is also possible that there are a plurality of the wide detection areas, and the camera is provided with an overlapping means for overlapping the wide detection area in which an intruder is present with the scope of the image-taking area of the camera.

In this case, since the surveillance camera system is arranged with a plurality of wide detection areas and is provided with an overlapping means for the camera, even if the plurality of detection areas are arranged in places removed from each other, the control portion simultaneously performs the transmission of an image-taking signal commanding the camera to perform image-taking in the sectional detection areas upon detection of the intruder while the image-taking area of the camera is being changed to the wide detection area in which the intruder is present, and therefore the time until wide-angle image-taking and enlarged image-taking of the intruder are performed by the camera upon detection of the intruder can be shortened.

Also, since it is possible to perform image-taking of wide detection areas that are formed in removed places without increasing the number of cameras, which is thus preferable for reducing costs.

In the above-described configuration, it is also possible that there are a plurality of the wide detection areas, and a plurality of the cameras provided respectively corresponding to these wide detection areas.

In this case, since there are a plurality of the wide detection areas, and a plurality of the cameras provided respectively corresponding to these wide detection areas, it is possible to perform image-taking of the intruder almost simultaneous to detection of the intruder by sending a detection signal from the control portion of the sensor to the camera whose image-taking area is facing that wide detection area. In this way, it is possible to eliminate the time taken to move the camera to face the wide detection area in which the intruder is present, and thus the time until image-taking is performed can be shortened.

In the above-described configuration, it is also possible that the sensor is a microwave sensor that detects an intruder using microwaves.

In this case, since the sensor uses microwaves, it is preferable for wide-angle image-taking. And although it is necessary to calculate the distance from the sensor to the intruder to define the detection area when using microwaves to detect an intruder, it is possible to perform one of wide-angle image-taking and enlarged image-taking while calculating the distance from the sensor to the intruder to define the detection area in order to perform the other image-taking. The result of this is that the time until image-taking is performed can be shortened.

### BRIEF DESCRIPTION OF THE DRAWINGS

FIG. 1 is a diagram of the overall configuration of a surveillance camera system according to an embodiment of the present invention.

FIG. 2 is an overall block diagram of the sensors arranged in a surveillance camera system according to an embodiment of the present invention.

FIG. 3 is a flowchart showing the process of image-taking of an intruder when using a surveillance camera system according to an embodiment of the present invention.

FIG. 4 is a flowchart showing the process of image-taking of an intruder when using a conventional surveillance camera system.

FIG. 5 is a diagram of the overall configuration of a surveillance camera system according to another embodiment of the present invention.

FIG. 6 is a diagram of the overall configuration of a conventional sensor.

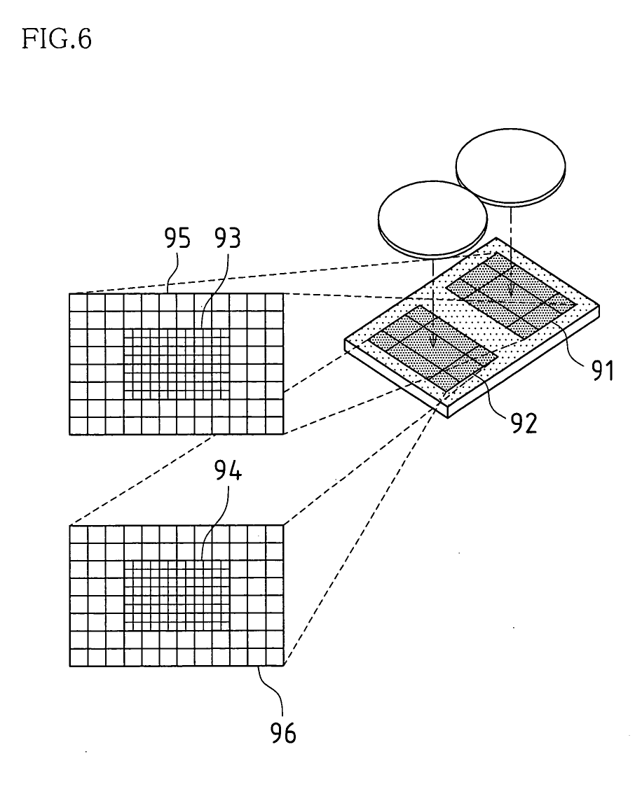

### DESCRIPTION OF THE PREFERRED EMBODIMENTS

Hereinafter, embodiments of the invention are described with reference to the appended drawings.

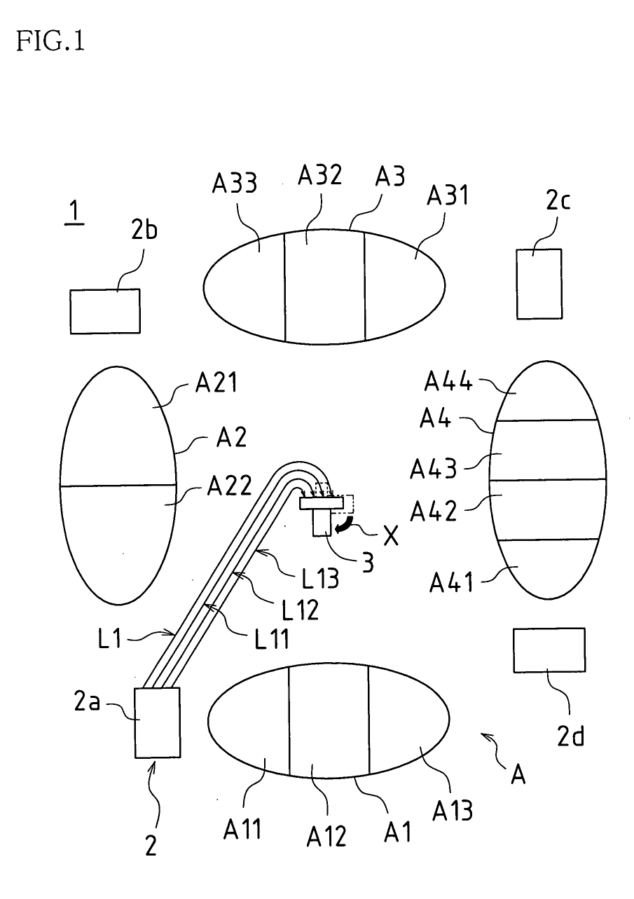

As shown in FIG. 1, four sensors 2 (2a, 2b, 2c, and 2d), which detect an intruder in respective removed locations within a detection area A, and a camera 3 that performs image-taking of an intruder are connected and arranged in a surveillance camera system 1 according to the present invention. Image-taking of an intruder is performed by the camera 3 after the intruder is detected in the detection area A by any of the sensors 2.

As shown in FIG. 1, the detection area A is constituted by four wide detection areas A1, A2, A3, and A4. Furthermore, the wide detection area A1 is divided into three sectional detection areas A11, A12, and A13; the wide detection area A2 is divided into two sectional detection areas A21 and A22; the wide detection area A3 is divided into three sectional detection areas A31, A32, and A33; and the wide detection area A4 is divided into four sectional detection areas A41, A42, A43, and A44.

The image-taking of an intruder by the camera 3 is performed with wide-angle image-taking in the wide detection areas A1, A2, A3, and A4, and enlarged image-taking in the sectional detection areas A11, A12, A13, A21, A22, A31, A32, A33, A41, A42, A43, and A44. Furthermore, the camera 3 is provided with an overlapping means for overlapping the detection area A in which the intruder is present with the scope of the image-taking area. The overlapping means is provided with a turning mechanism so that the image-taking area of the camera 3 can be faced toward any of the detection areas A.

The following is a description of the configuration of the sensors 2 using as an example the sensor 2a, which takes the wide detection area A1 as its target for detection. It should be noted that the other sensors 2b, 2c, and 2d are the same, the only difference being the number of antennas (see below) corresponding to the sectional detection areas, and thus explanation of these is omitted.

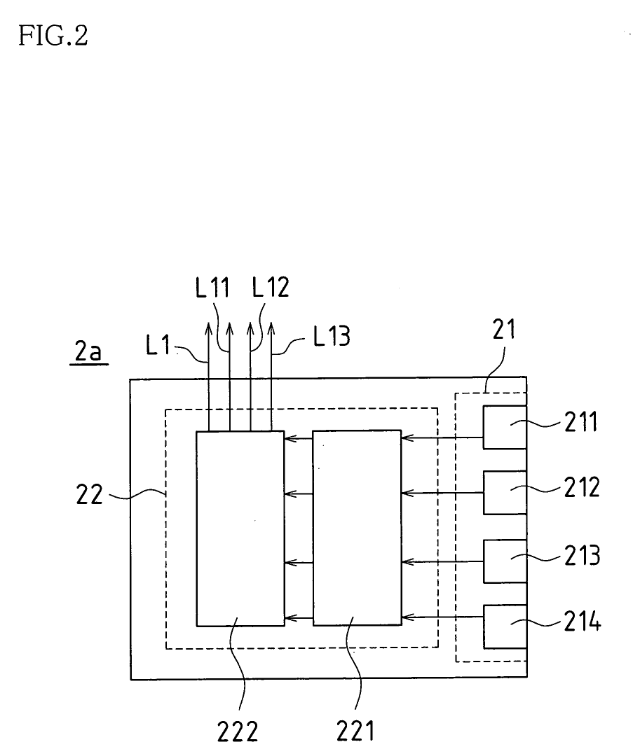

The sensor 2a is a microwave sensor that uses dual-frequency microwaves (hereafter “MW”) to detect an intruder, and, as shown in FIG. 2, the sensor 2a transmits MW to detectable detection areas A1, A11, A12, and A13. The sensor 2a is provided with: an antenna portion 21 that receives waves (MW modulated by the Doppler effect) reflected by an intruder when an intruder is present in any of the detection areas A1, A11, A12, and A13; and a control portion 22 that simultaneously controls two signals upon the detection of an intruder, sending an image-taking signal commanding the camera 3 to perform image-taking upon the detection of an intruder in the wide detection area A1, and sending an image-taking signal commanding the camera 3 to perform image-taking upon detection of an intruder in any of the sectional detection areas A11, A12, and A13.

The antenna portion 21 is constituted by antennas 211, 212, 213, and 214 that respectively correspond to the detection areas A1, A11, A12, and A13.

The control portion 22 determines whether or not MW are received at the antenna portion 21, and is made of a determination control portion 221 that calculates the distance from the antenna portion 21 to the intruder and determines which of the detection areas A1, A11, A12, and A13 an intruder is present in; and a transmission control portion 222 that sends an image-taking signal commanding the camera 3 to perform image-taking in the detection areas A1, A11, A12, and A13, depending on the result determined by the determination control portion 221.

The transmission control portion 222 controls the transmission of the image-taking signals that command the camera 3 to perform image-taking in such a way that the camera 3 performs enlarged image-taking after performing wide-angle image-taking of the intruder.

Furthermore, as shown in FIG. 2, the sensor 2a and the camera 3 are connected by transmission lines L1, L11, L13, which correspond to the detection areas A1, A11, A12, and A13, and are for sending image-taking signals that command the camera 3 to perform image-taking upon detection of an intruder by the antennas 211, 212, 213, and 214 in the four detectable detection areas A1, A11, A12, and A13. It should be noted that transmission lines that are equivalent to that for the sensor 2a are also used for connecting the sensors 2b, 2c, and 2d and the camera 3, and are therefore omitted from FIG. 1.

### Embodiments

Using FIGS. 1, 3, and 4, performing image-taking of an intruder and the time until image-taking of the intruder is performed when using the surveillance camera system 1 will be compared with performing image-taking of an intruder and the time until image-taking of the intruder is performed when using a conventional surveillance camera system that uses wide-angle image-taking.

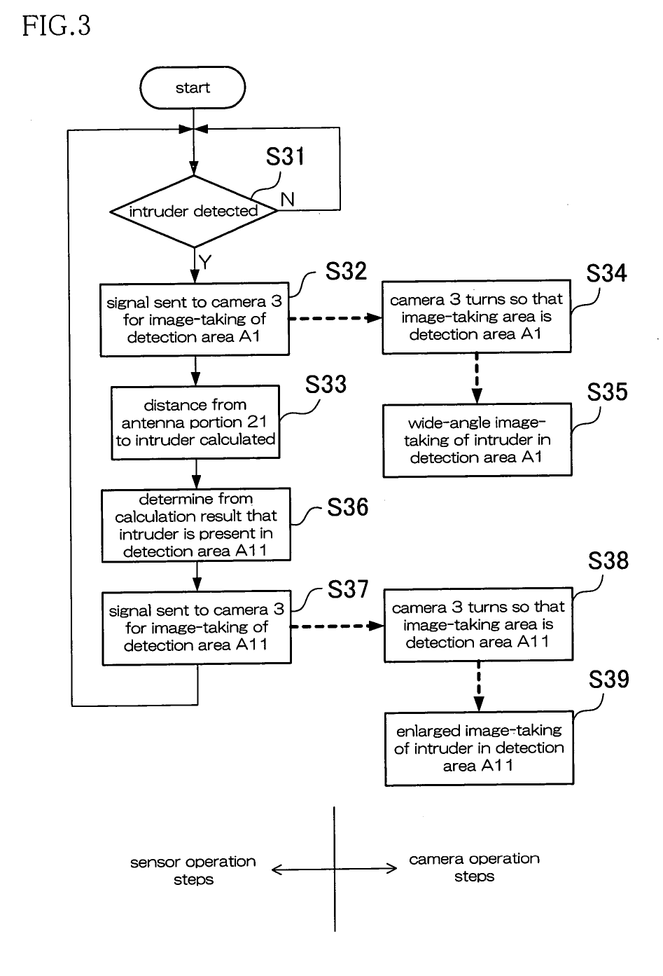

Performing image-taking of an intruder and the time until image-taking of the intruder is performed when using the surveillance camera system 1 will be described first using FIGS. 1 and 3.

An intruder is detected in the detection area A1 by the antenna portion 21 (Y in step S31).

After Y in step S31, a signal is sent from the transmission control portion 222 to the camera 3 to perform image-taking of the detection area A1 (step S32).

After step S32, the distance from the antenna portion 21 to the intruder in the detection area A1 is calculated by the determination control portion 221 (step S33). It should be noted that the time required for the process of step S33 is approximately 1.5 seconds.

Moreover, based on the signal sent in step S32 for performing image-taking of the detection area A1, the camera 3 is turned by the turning mechanism in the direction shown in FIG. 1 by the arrow X so that the image-taking area changes from the detection area A4 to the detection area A1 (step S34). The time required for the process of step S34 is approximately 1.0 seconds.

After step S34, wide-angle image-taking is performed of the intruder in the detection area A1 (step S35). It should be noted that the process of step S33 is carried out during steps S34 and S35.

The result of calculating in step S33 the distance from the antenna portion 21 to the intruder is that it is determined that the intruder is present in the detection area A11 (step S36).

Based on the result determined in step S36, a signal is sent from the transmission control portion 222 to the camera 3 to perform image-taking of the detection area A11 (step S37). It should be noted that when the process of step S37 is finished, the sensor 2a carries out detection for a new intruder intruding in the detection area A1.

Based on the signal sent in step S37 for performing image-taking of the detection area A1, the camera 3 is turned by the turning mechanism so that the image-taking area changes from the detection area A1 to the detection area A11 (step S38). The time required for the process of step S38 is approximately 0.5 seconds.

After step S38, enlarged image-taking is performed of the intruder in the detection area A11 (step S39), and image-taking of the intruder finishes.

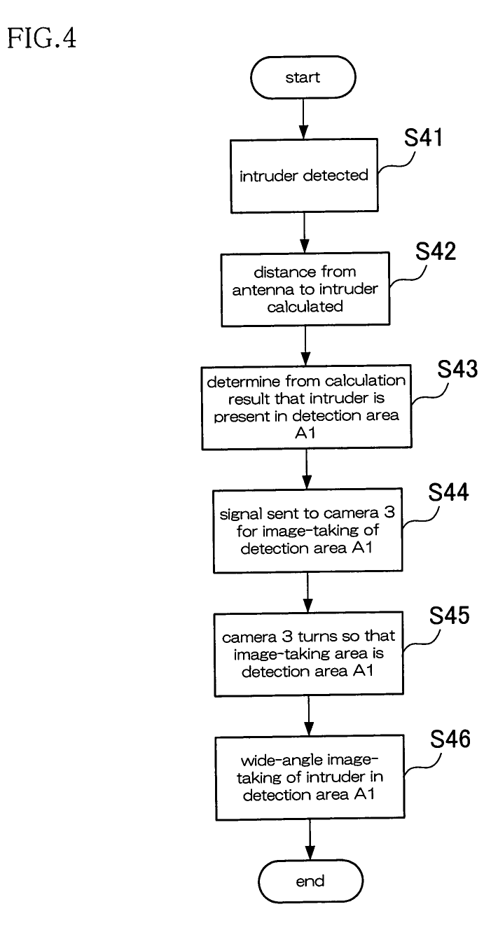

Next, performing image-taking of an intruder and the time until image-taking of the intruder is performed when using a conventional surveillance camera system will be described using FIGS. 1 and 4. This conventional surveillance camera system is arranged the same as the surveillance camera system 1 in FIG. 1, and therefore can be explained using FIG. 1. It should be noted that since this conventional surveillance camera system can only perform wide-angle image-taking, it is provided with only the wide detection areas A1, A2, A3, and A4, and each sensor corresponding to these is arranged with one antenna.

An intruder is detected in the detection area A1 by an antenna (omitted from drawing) of the sensor 2a (step S41).

After step S41, the distance from the antenna to the intruder in the detection area A1 is calculated (step S42). The time required for the process of step S42 is approximately 1.5 seconds.

The result of calculating in step S42 the distance from the sensor 2a to the intruder is that it is determined that the intruder is present in the detection area A1 (step S43).

Based on the result determined in step S43, a signal is sent to the camera 3 to perform image-taking of the detection area A1 (step S44).

Based on the signal sent in step S44 for image-taking of the detection area A1, the camera 3 is turned by the turning mechanism in the direction shown in FIG. 1 by the arrow X so that the image-taking area changes from the detection area A4 to the detection area A1 (step S45). The time required for the process of step S45 is approximately 1.0 seconds.

After step S45, wide-angle image-taking of the intruder in the detection area A11 is performed (step S46), then image-taking of the intruder finishes.

The following Table 1 provides an overview of the time until image-taking of the intruder is performed when using the surveillance camera system 1 and the time until image-taking of the intruder is performed when using a conventional surveillance camera system.

TABLE 1

| | | | Camera | Camera | |
|---|---|---|---|---|---|
| | | Calculating | operation for | operation for | |
| | | detection | changing | changing | Total time |
| | | area in | image-taking | image-taking | until |
| | | which | area to | area to | image-taking |
| | | intruder is | detection | detection | of intruder is |
| | | detected | area A1 | area A11 | performed |
| Surveillance | Time until | Approx. 1.5 sec. | | Approx. 0.5 sec. | Approx. 2.0 sec. |
| camera | image-taking | | | | |
| system | of intruder is | | | | |
| according to | performed | | | | |
| the present | Process time | | Approx. 1.0 sec. | | |
| invention | of step S34 | | | | |
| | performed | | | | |
| | during | | | | |
| | process of | | | | |
| | step S33 | | | | |
| Conventional | Time until | Approx. 1.5 sec. | Approx. 1.0 sec. | | Approx. 2.5 sec. |
| surveillance | image-taking | | | | |
| camera | of intruder is | | | | |
| system | performed | | | | |

As shown in Table 1, the time until image-taking of the intruder is performed when using the surveillance camera system 1 is approximately 2.0 seconds, which is the sum of the time until wide-angle image-taking is performed and the time until enlarged image-taking is performed. In contrast to this, the time until image-taking of the intruder is performed when using the conventional surveillance camera system is approximately 2.5 seconds for just the time until wide-angle image-taking is performed. In this way, not only is it possible to perform both wide-angle image-taking and enlarged image-taking by using the surveillance camera system 1, but it is also possible to shorten the total image-taking time by approximately 0.5 seconds compared to the conventional surveillance camera system.

Thus, with the surveillance camera system 1 according to the present invention, which was described using an example of the image-taking process with the sensor 2a, since the image-taking of an intruder with the camera 3 is performed with enlarged image-taking and wide-angle image-taking, and since the detection area of the sensor 2a is constituted by the wide detection area A1 and the sectional detection areas A11, A12, and A13, and since the control portion 22 is provided in the sensor 2a, it is possible to simultaneously perform the transmission of the image-taking signal commanding the camera 3 to perform image-taking upon detection of an intruder in the wide detection area A1, and the transmission of the image-taking signal commanding the camera 3 to perform image-taking upon detection of an intruder in any of the sectional detection areas A11, A12, and A13. Therefore, the wide-angle image-taking in the wide detection area A1 and the enlarged image-taking in the sectional detection areas A11, A12, and A13 can be performed consecutively and the intruder can be specified reliably with wide-angle image-taking and enlarged image-taking.

Moreover, with the control portion 22, since the transmission of the image-taking signal commanding the camera 3 to perform image-taking upon detection of an intruder in a wide detection area, for example the wide detection area A1 of the sensor 2a, and the transmission of the image-taking signal commanding the camera 3 to perform image-taking upon detection of an intruder in any of the sectional areas A11, A12, and A13 are performed simultaneously upon detection of the intruder, it is possible to shorten the time taken from detection of the intruder until wide-angle image-taking and enlarged image-taking of the intruder are performed by the camera 3.

Furthermore, since the transmission of the image-taking signals is controlled by a control portion, for example the control portion 22 provided in the sensor 2a, in such a way that enlarged image-taking of the intruder is performed after wide-angle image-taking with the camera 3, it is possible, first, to reliably perform image-taking of the intruder with wide-angle image-taking, and then, to perform enlarged image-taking for specifying the intruder, thus preventing the failure to perform image-taking of the intruder and enabling image-taking to be performed reliably and the intruder to be specified.

And since the surveillance camera system 1 is formed with four wide detection areas and is provided with a turning mechanism for the camera 3, even if the four wide detection areas A1, A2, A3, and A4 are formed in places removed from each other, the control portion 22 provided in the sensor 2a carries out the transmission of an image-taking signal commanding the camera 3 to perform image-taking in the sectional detection areas A11, A12, and A13 upon detection of the intruder while the image-taking area of the camera 3 is being changed to the wide detection area, for example the wide detection area A1, in which the intruder is present, and therefore the time until wide-angle image-taking and enlarged image-taking of the intruder are performed by the camera 3 upon detection of the intruder can be shortened.

Also, since a single camera is used for the four wide detection areas, it is possible to perform image-taking in wide detection areas A1, A2, A3, and A4 that are formed in removed places without increasing the number of the camera 3, which is thus preferable for reducing costs.

Furthermore, the sensor 2 is preferable for wide-angle image-taking as it uses MW. And although it is necessary to calculate the distance from the antenna portion 21 to the intruder to define the detection area A1 when using MW to detect an intruder, it is possible, while performing wide-angle image-taking, to calculate the distance from the antenna portion 21 to the intruder to define the detection area in order to perform enlarged image-taking. For this reason, the time until image-taking of the intruder is performed can be shortened.

It should be noted that a dual-frequency MW sensor is used in the sensors 2a, 2b, 2c, and 2d according to the present embodiment, but this is not a limitation, and as long as the intruder can be detected, it is also possible to use single-frequency MW, or an optical system such as PIR for example.

Also, the sensors 2a, 2b, 2c, and 2d are used in the present embodiment, but this is not a limitation, and a configuration in which a single sensor is used for detection in a plurality of wide detection areas is also possible.

Furthermore, in the present embodiment, enlarged image-taking is performed after wide-angle image-taking is performed, but this is not a limitation, and it is possible to perform wide-angle image-taking after enlarged image-taking is performed.

Also, in the present embodiment, a turning mechanism that turns the camera itself is used as the overlapping means for the camera 3, but this is not a limitation, and it is also possible to configure this in such ways as varying the angle of the camera lens, and providing a mirror for the camera and varying the reflectance angle of the mirror so that the image-taking area is changeable.

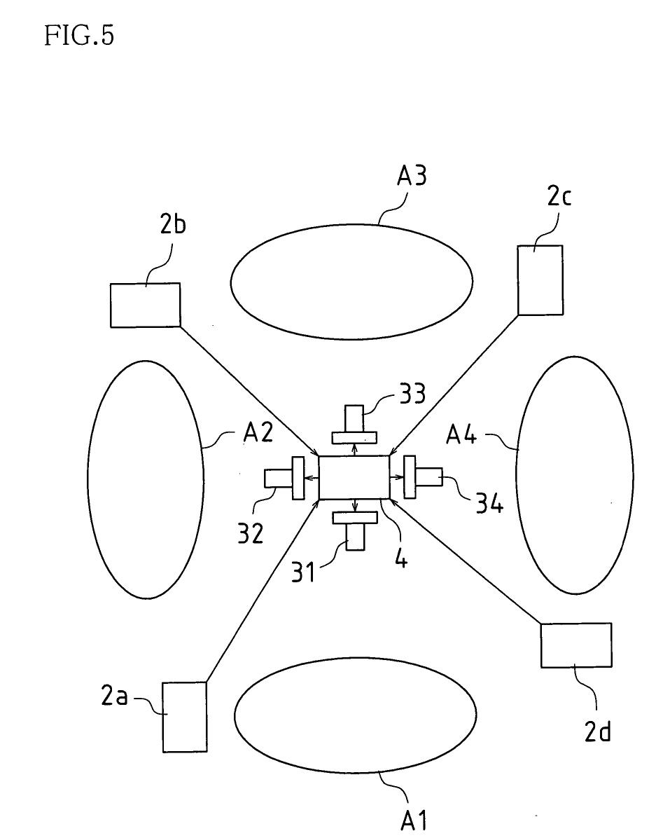

Furthermore, a single camera 3 is arranged for the four sensors 2a, 2b, 2c, and 2d in the present embodiment, but this is not a limitation, and as shown in FIG. 5, it is also possible to arrange four cameras (31, 32, 33, and 34) respectively facing the four wide detection areas A1, A2, A3, and A4 for image-taking. It should be noted that the four sensors 2a, 2b, 2c, and 2d, and the four cameras 31, 32, 33, and 34 are connected via a camera control portion 4 that selects of the camera that is to be driven.

In this case, when an intruder is detected in a wide detection area of any of the wide detection areas A1, A2, A3, and A4, it is possible to perform image-taking of the intruder almost simultaneous to detection of the intruder by sending a detection signal from the control portion of the sensor to the camera whose image-taking area is facing that wide detection area. In this way, it is possible to eliminate the time to move the camera to face the wide detection area in which the intruder is present when the image-taking area of the camera is a detection area in which the intruder is not present, and thus the time until image-taking of the intruder is performed can be shortened.

It should be noted that in FIG. 5, the cameras 31, 32, 33, and 34 are respectively provided facing the image-taking areas of the four wide detection areas A1, A2, A3, and A4, but this is not a limitation. The number of cameras is not limited, since having a number of cameras, for example two cameras, that is not the same as the number of wide detection areas provides the surveillance camera system shown in FIG. 5 with the same operational effect as compared to the case of using a single camera for image-taking with a plurality of wide detection areas.

As described above, with the surveillance camera system according to the present invention, the time from detection of an intruder to image-taking of the intruder with a camera can be shortened, and the intruder can be specified with reliable image-taking. For this reason, the surveillance camera system according to the present invention is effective particularly as an outdoor surveillance camera system.

In other words, with the surveillance camera system according to the present invention, image-taking of the intruder by camera is performed with enlarged image-taking and wide-angle image-taking, and the detection area is constituted by a wide detection area and sectional detection areas, and the sensor is provided with a control portion so that transmission of an image-taking signal commanding the camera to perform image-taking upon detection of an intruder in the wide detection area, and transmission of an image-taking signal commanding the camera to perform image-taking upon the detection of an intruder in the sectional detection areas, are performed simultaneously upon detection of the intruder. In this way, it is possible to perform wide-angle image-taking in the wide detection area, and enlarged image-taking in the sectional detection areas, thus enabling the intruder to be reliably specified with wide-angle image-taking and enlarged image-taking. Furthermore, with the control portion, transmission of an image-taking signal commanding the camera to perform image-taking upon detection of an intruder in the wide detection area, and transmission of an image-taking signal commanding the camera to perform image-taking upon the detection of an intruder in the sectional detection areas are performed simultaneously upon detection of the intruder, and therefore the time until wide-angle image-taking and enlarged image-taking are performed of the intruder by the camera upon detection of the intruder can be shortened.

It should be noted that this application is based on Japanese Patent Application 2003-010870 filed in Japan, which is incorporated herein by reference. The entirety of any literature to which reference is made in this specification is specifically incorporated herein by reference.

What is claimed is:

1. A surveillance camera system comprising a sensor that detects an intruder in a detection area and a camera that performs image-taking of the intruder, wherein image-taking of the intruder is performed with the camera after the intruder is detected in the detection area by the sensor,
wherein the image-taking of the intruder by the camera is performed with enlarged image-taking and wide-angle image-taking,
wherein the detection area is constituted by a wide detection area in which the wide-angle image-taking is performed, and a plurality of sectional detection areas into which the wide detection area is divided and in which enlarged image-taking is performed, and
wherein the sensor is provided with a control portion that simultaneously performs transmission of an image-taking signal commanding the camera to perform image-taking upon detection of an intruder in the wide detection area, and transmission of an image-taking signal commanding the camera to perform image-taking upon the detection of an intruder in the sectional detection areas, upon detection of the intruder.

2. The surveillance camera system according to claim 1,
wherein the control portion controls the transmission of the image-taking signals so that the enlarged image-taking is performed after the wide-angle image-taking of the intruder by the camera.

3. The surveillance camera system according to claim 1 or 2,
wherein there are a plurality of the wide detection areas, and the camera is provided with an overlapping means for overlapping the wide detection area in which an intruder is present with the scope of the image-taking area of the camera.

4. The surveillance camera system according to claim 1 or 2,
wherein there are a plurality of the wide detection areas, and a plurality of the cameras are provided respectively corresponding to these wide detection areas.

5. The surveillance camera system according to claim 1 or 2,
wherein the sensor is a microwave sensor that detects an intruder using microwaves.

6. The surveillance camera system according to claim 1 or 2,
wherein the sensor is a microwave sensor that detects an intruder using microwaves, and
wherein there are a plurality of the wide detection areas, and the camera is provided with an overlapping means for overlapping the wide detection area in which an intruder is present with the scope of the image-taking area of the camera.

7. The surveillance camera system according to claim 1 or 2,
wherein the sensor is a microwave sensor that detects an intruder using microwaves, and
wherein there are a plurality of the wide detection areas, and a plurality of the cameras are provided respectively corresponding to these wide detection areas.
